(19) United States
(12) Patent Application Publication
(10) Pub. No.: US 2015/0029398 A1
(43) Pub. Date: Jan. 29, 2015

(54) INFORMATION PROCESSING APPARATUS AND INFORMATION PROCESSING METHOD FOR OUTPUTTING A CHARGING STATUS

(71) Applicant: KABUSHIKI KAISHA TOSHIBA, Tokyo (JP)

(72) Inventors: Akira Ichie, Ome-shi (JP); Takanori Yamaguchi, Hamura-shi (JP); Hiroki Yamanaka, Ome-shi (JP); Hajime Suda, Hamura-shi (JP); Masami Tanaka, Ome-shi (JP)

(73) Assignee: KABUSHIKI KAISHA TOSHIBA, Tokyo (JP)

(21) Appl. No.: 14/142,409

(22) Filed: Dec. 27, 2013

Related U.S. Application Data
(60) Provisional application No. 61/857,947, filed on Jul. 24, 2013.

(51) Int. Cl. H04N 5/63

(52) U.S. Cl. CPC H04N 5/63
USPC 348/552

(57) ABSTRACT

According to one embodiment, an information processing apparatus includes a terminal, power supply module, measurement module, prediction module, and output module. The terminal is configured to connect with a cable from a chargeable external apparatus. The power supply module is configured to connect the terminal and to supply electric power to the external apparatus via the terminal. The measurement module is configured to measure a supplied power from the power supply module. The prediction module is configured to predict a charging status of the external apparatus based on the measurement result of the supplied power. The output module is configured to output the charging status.

### CROSS-REFERENCE TO RELATED APPLICATIONS

This application claims the benefit of U.S. Provisional Application No. 61/857,947, filed Jul. 24, 2013, the entire contents of which are incorporated herein by reference.

### FIELD

Embodiments described herein relate generally to an information processing apparatus and information processing method.

### BACKGROUND

Conventionally, electronic apparatuses which can record (video-record) and play back video content (streams) of movies, television programs, or games have prevailed.

Also, electronic apparatuses which support standards required to transmit streams such as High-Definition Multimedia Interface® (HDMI®) and Mobile High-definition Link® (MHL®) have prevailed.

An electronic apparatus (source) on the stream output side outputs a stream to an electronic apparatus (sink) on the stream receiving side. The sink plays back the received stream, and displays a played-back video on a display. When the source and sink are connected to each other via MHL, they can mutually operate and control partner apparatuses. Furthermore, the sink can supply electric power to the source via an MHL cable.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a view for explaining a transmission/reception system according to one embodiment;

FIG. 2 is a block diagram for explaining the transmission/reception system according to one embodiment;

FIG. 3 is a block diagram for explaining the transmission/reception system according to one embodiment;

FIG. 4 is a block diagram for explaining the transmission/reception system according to one embodiment;

FIG. 5 is a view showing a connection example between a video processing apparatus and portable device according to one embodiment;

FIG. 6 is a table showing an example of MHL signal lines used to connect the video processing apparatus and portable device according to one embodiment;

FIG. 7 is a graph showing a display example of a charging status according to one embodiment;

FIG. 8 is a graph showing a display example of a charging status according to one embodiment;

FIG. 9 is a graph showing a display example of a charging status according to one embodiment;

FIG. 10 is a graph showing a display example of a charging status according to one embodiment;

FIG. 11 is a graph showing a display example of a charging status according to one embodiment;

FIG. 12 is a graph showing a display example of a charging status according to one embodiment.

### DETAILED DESCRIPTION

Various embodiments will be described hereinafter with reference to the accompanying drawings.

In general, according to one embodiment, an information processing apparatus includes a terminal, power supply module, measurement module, prediction module, and processor. The terminal is configured to receive a cable from a chargeable external apparatus. The power supply module is configured to connect the terminal and to supply electric power to the external apparatus via the terminal. The processor is configured to measure a supplied power supplied form the power supply module. The processor is configured to predict a charging status of the external apparatus based on the measurement result of the supplied power. The processor is configured to output the charging status.

A transmission apparatus, reception apparatus, and transmission/reception system according to one embodiment will be described hereinafter with reference to the drawings.

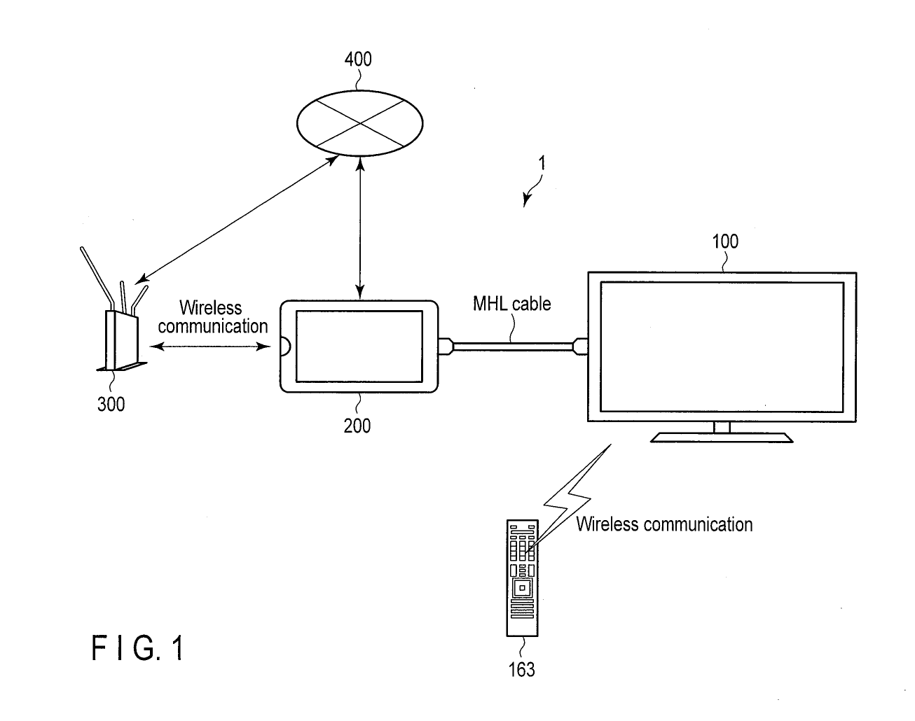

FIG. 1 shows an example of a transmission/receptor system 1 including a plurality of electronic apparatuses. The transmission/receptor system 1 includes, for example, a video processing apparatus 100, portable device 200, wireless communication device 300, and the like.

The video processing apparatus 100 is an electronic apparatus such as a broadcast receiver, which can play back, for example, broadcast signals or video content stored in storage media. The video processing apparatus 100 can wirelessly communicate with a remote controller 163.

The portable device 200 is an electronic apparatus including a display, operation unit, and communication unit. The portable device 200 is, for example, a mobile phone, tablet computer, portable music player, game console, Digital Versatile Disc (DVD) recorder, set-top box, or other electronic apparatus.

The wireless communication device 300 can communicate with the video processing apparatus 100 and portable device 200 via wireless or wired communications. That is, the wireless communication device 300 functions as an access point of wireless communications. Also the wireless communication device 300 can be connected to a network 400 such as an external cloud service. That is, the wireless communication device 300 can access the network 400 in response to a request from the video processing apparatus 100 or portable device 200. Thus, the video processing apparatus 100 and portable device 200 can acquire various data from a server on the network 400 via the wireless communication device 300.

The video processing apparatus 100 is connected to the portable device 200 via a communication cable conforming to the MHL (MHL cable) standard. The MHL cable has a connector having a shape conforming to the HDMI standard (HDMI terminal) on one end, and a connector having a shape conforming to the USB standard (for example, microUSB) (USB terminal) on the other end.

The MHL is the interface standard which can transmit moving image data (stream) including a video and moving image. In the MHL, an electronic apparatus (source) on the stream output side outputs a stream to an electronic apparatus (sink) on the stream reception side via the MHL cable. The sink can play back the received stream, and can display a played-back video on a display. The source and sink can operate and control partner apparatuses by transmitting commands to the apparatuses connected via the MHL cable.

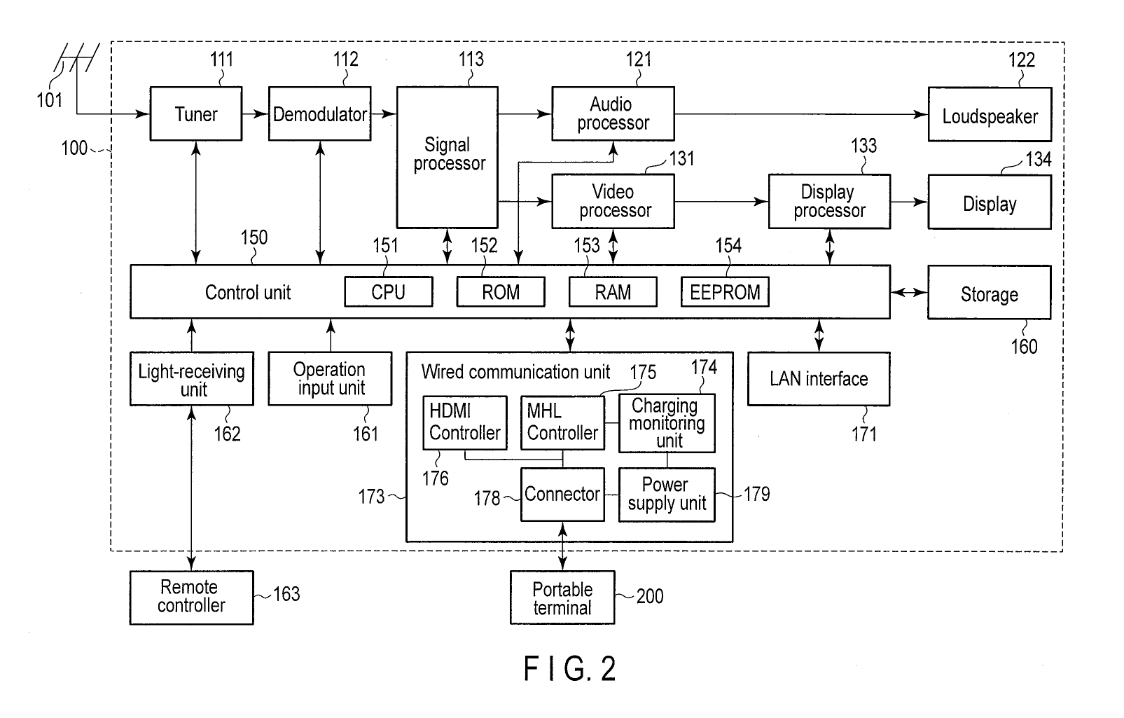

FIG. 2 shows an example of the video processing apparatus 100.

The video processing apparatus 100 is an electronic apparatus such as a broadcast receiver or recorder which can play back, for example, a broadcast signal or video content stored on a storage medium.

The video processing apparatus 100 includes a tuner 111, demodulator 112, signal processor 113, audio processor 121, video processor 131, display processor 133, control unit 150, storage 160, operation input unit 161, light-receiving unit 162, LAN interface 171, and wired communication unit 173. Also, the video processing apparatus 100 further includes a loudspeaker 122 and display 134.

The tuner 111 receives a digital broadcast signal picked up by, for example, an antenna 101. The antenna 101 can receive, for example, a terrestrial digital broadcast signal or a direct-to-home digital broadcast signal delivered via a direct-broadcast satellite or fixed-service satellite. The tuner 111 can receive data (streams) of content such as programs supplied by the digital broadcast signal.

The tuner 111 is that for digital broadcast signals. The tuner 111 tunes the received digital broadcast signal. The tuner 111 transmits the tuned digital broadcast signal to the demodulator 112. Note that the video processing apparatus 100 may include a plurality of tuners 111. The video processing apparatus 100 can simultaneously tune a plurality of broadcast signals using the plurality of tuners.

The demodulator 112 demodulates the received digital broadcast signal. Thus, the demodulator 112 acquires moving image data (to be referred to as a stream hereinafter) such as a transport stream (TS) from the digital broadcast signal. The demodulator 112 inputs the acquired stream to the signal processor 113. Note that the video processing apparatus 100 may include a plurality of demodulators 112. The plurality of demodulators 112 can respectively demodulate a plurality of signals tuned by the plurality of tuners 111.

As described above, the antenna 101, tuner 111, and demodulator 112 function as a reception unit which receives a stream.

The signal processor 113 executes signal processing such as demultiplexing of a stream. That is, the signal processor 113 demultiplexes the stream into a digital video signal, digital audio signal, and other data signals. Note that the signal processor 113 can demultiplex a plurality of streams demodulated by the plurality of demodulators 112. The signal processor 113 supplies the digital audio signal to the audio processor 121. Also, the signal processor 113 supplies the digital video signal to the video processor 131. Furthermore, the signal processor 113 supplies the data signals to the control unit 150.

Also, the signal processor 113 can convert the stream into video-recordable data (video-recordable stream) under the control of the control unit 150. The signal processor 113 can supply the video-recordable stream to the storage 160 or other modules under the control of the control unit 150.

Furthermore, the signal processor 113 can convert (transcode) a bitrate of the stream from an original bitrate to another bitrate. That is, the signal processor 113 can transcode a stream of an original bitrate acquired based on a broadcast signal or the like into that of a lower bitrate. Thus, the signal processor 113 can video-record a content in a capacity-reduced state.

The audio processor 121 converts the digital audio signal received from the signal processor 113 into a signal of a format which can be played back via the loudspeaker 122 (audio signal). For example, the audio processor 121 converts the digital audio signal into an audio signal by digital-to-analog conversion. The audio processor 121 supplies the audio signal to the loudspeaker 122. The loudspeaker 122 outputs sound based on the supplied audio signal.

The video processor 131 converts the digital video signal received from the signal processor 113 into a video signal of a format which can be played back by the display 134. That is, the video processor 131 decodes (plays back) the digital video signal received from the signal processor 113 into a video signal of a format which can be played back by the display 134. The video processor 131 outputs the video signal to the display processor 133.

The display processor 133 applies, for example, image quality adjustment processing of a color, brightness, sharpness, contrast, and the like to the received video signal under the control of the control unit 150. The display processor 133 supplies the video signal which has undergone the image quality adjustment to the display 134. The display 134 displays a video based on the supplied video signal.

The display 134 includes a liquid crystal display device including a liquid crystal display panel which includes a plurality of pixels arranged in a matrix, and a backlight which illuminates this liquid crystal display panel, and the like. The display 134 displays a video based on the video signal supplied from the display processor 133.

Note that the video processing apparatus 100 may have an arrangement including an output terminal used to output the video signal in place of the display 134. Also, the video processing apparatus 100 may have an arrangement including an output terminal used to output the audio signal in place of the loudspeaker 122. Furthermore, the video processing apparatus 100 may have an arrangement including output terminals used to output the digital video signal and digital audio signal.

The control unit 150 functions as a control unit which controls the operations of the respective units of the video processing apparatus 100. The control unit 150 includes a CPU 151, ROM 152, RAM 153, EEPROM (nonvolatile memory) 154, and the like. The control unit 150 executes various kinds of processing based on operation signals supplied from the operation input unit 161.

The CPU 151 includes an arithmetic element used to execute various kinds of arithmetic processing, and the like. The CPU 151 implements various functions by executing programs stored in the ROM 152, EEPROM 154, or the like.

The ROM 152 stores programs required to control the video processing apparatus 100, those required to implement various functions, and the like. The CPU 151 launches a program stored in the ROM 152 based on an operation signal supplied from the operation input unit 161. Thus, the control unit 150 controls the operations of the respective units.

The RAM 153 functions as a work memory of the CPU 151. That is, the RAM 153 stores arithmetic results of the CPU 151, data loaded by the CPU 151, and the like.

The EEPROM 154 is a nonvolatile memory which stores various kinds of setting information, programs, and the like.

The storage 160 has a storage medium which stores content. For example, the storage 160 is configured by a hard disk drive (HDD), solid-state drive (SSD), semiconductor memory, or the like. The storage 160 can store the video-recordable stream supplied from the signal processor 113.

The operation input unit 161 includes, for example, operation keys, a touchpad, or the like used to generate operation signals in response to operation inputs by the user. The operation input unit 161 may have an arrangement which receives operation signals from a keyboard, mouse, or other input devices which can generate operation signals. The operation input unit 161 supplies operation signals to the control unit 150.

Note that the touchpad includes a device which generates position information based on a capacitive sensor, thermosensor, or other systems. When the video processing apparatus 100 includes the display 134, the operation input unit 161 may include a touchpanel formed integrally with the display 134.

The light-receiving unit 162 includes, for example, a sensor which receives an operation signal from the remote controller 163, and the like. The light-receiving unit 162 supplies the received signal to the control unit 150. The control unit 150 receives the signal supplied from the light-receiving unit 162, and amplifies and digitizes the received signal, thus decoding an original operation signal transmitted from the remote controller 163.

The remote controller 163 generates an operation signal based on an operation input of the user. The remote controller 163 transmits the generated operation signal to the light-receiving unit 162 via infrared communications. Note that the light-receiving unit 162 and remote controller 163 may exchange operation signals via other wireless communications such as radio signals.

The LAN interface 171 can communicate with other apparatuses on the network 400 via a LAN or wireless LAN and the wireless communication device 300. Thus, the video processing apparatus 100 can communicate with other apparatuses connected to the wireless communication device 300. For example, the video processing apparatus 100 can acquire and play back a stream recorded in an apparatus on the network 400 via the LAN interface 171.

The wired communication unit 173 is an interface which supports communication conforming to such standards as HDMI and MHL. The wired communication unit 173 includes a connector (HDMI/MHL terminal) 178, which can connect an HDMI cable or can also connect an MHL cable in place of the HDMI cable. Furthermore, the wired communication unit 173 includes an HDMI controller 176, which processes a signal from an external apparatus connected via the HDMI cable and connector 178, conforming to the HDMI standard, and an MHL controller 175, which processes a signal from an external apparatus (portable device 200) connected via the MHL cable and connector 178, conforming to the MHL standard. Furthermore, the wired communication unit 173 includes a power supply unit 179 which supplies electric power to an external apparatus (portable device 200) connected via the MHL cable and connector 178. Moreover, the wired communication unit 173 includes a charging monitoring unit 174 which measures a supplied power by the power supply unit 179.

Note that a connector of the MHL cable on the side connected to the video processing apparatus 100 includes a structure having compatibility with the HDMI cable. Note that in the MHL cable, a resistor is connected between terminals (detection terminals) which are not used in a communication. The wired communication unit 173 can recognize whether an MHL cable is connected or HDMI cable is connected to the HDMI/MHL terminal by applying a voltage to the detection terminals.

The video processing apparatus 100 can receive and play back a stream output from an apparatus (source) connected to the HDMI/MHL terminal of the wired communication unit 173.

The control unit 150 controls to input the stream received by the wired communication unit 173 to the signal processor 113. The signal processor 113 demultiplexes a digital video signal, digital audio signal, and the like from the received stream. The signal processor 113 transmits the demultiplexed digital video signal to the video processor 131, and the demultiplexed digital audio signal to the audio processor 121. Thus, the video processing apparatus 100 can play back the stream received by the wired communication unit 173.

The video processing apparatus 100 includes a power source unit (not shown). The power source unit receives electric power from a commercial power source via an AC adapter and the like. The power source unit converts the received AC electric power into DC power, and supplies the DC power to the respective units in the video processing apparatus 100.

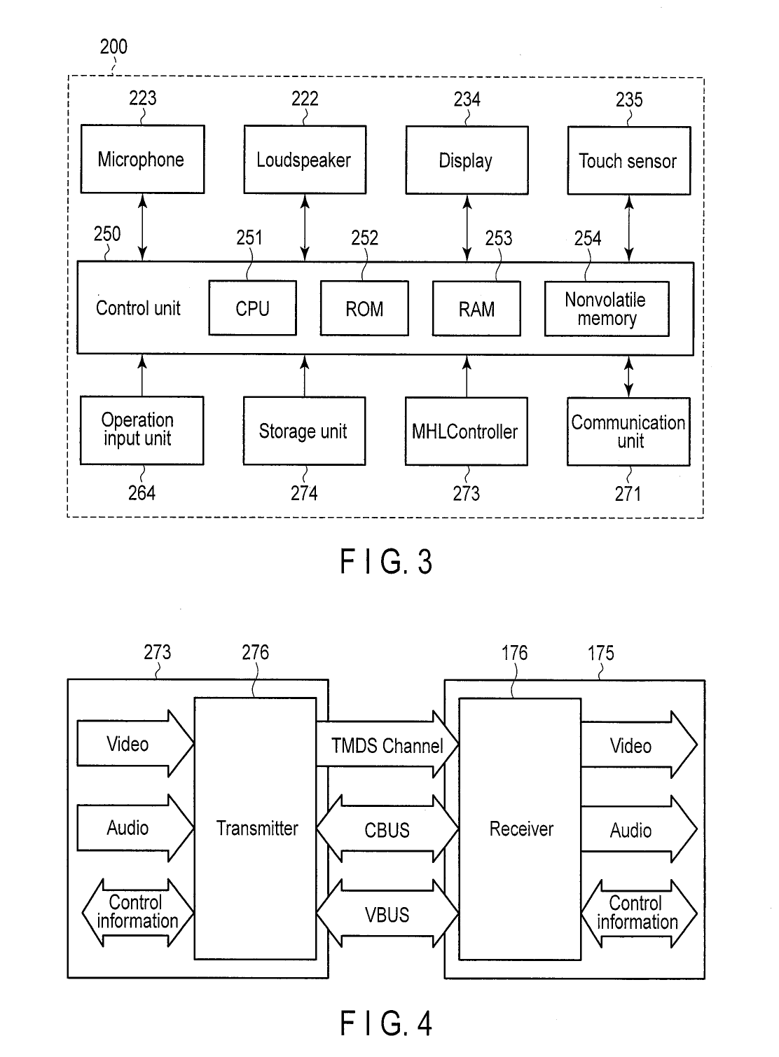

FIG. 3 shows an example of the portable device 200 according to one embodiment.

The portable device 200 includes a control unit 250, operation input unit 264, communication unit 271, MHL controller 273, and storage unit 274. Furthermore, the portable device 200 includes a loudspeaker 222, microphone 223, display 234, and touch sensor 235.

The control unit 250 functions as a control unit which controls operations of respective units of the portable device 200. The control unit 250 includes a CPU 251, ROM 252, RAM 253, nonvolatile memory 254, and the like. The control unit 250 executes various kinds of processing based on operation signals supplied from the operation input unit 264 or touch sensor 235.

The CPU 251 includes an arithmetic element used to execute various kinds of arithmetic processing, and the like. The CPU 251 implements various functions by executing programs stored in the ROM 252, nonvolatile memory 254, or the like.

The ROM 252 stores programs required to control the portable device 200, those required to implement various functions, and the like. The CPU 251 launches a program stored in the ROM 252 based on an operation signal supplied from the operation input unit 264. Thus, the control unit 250 controls the operations of the respective units.

The RAM 253 functions as a work memory of the CPU 251. That is, the RAM 253 stores arithmetic results of the CPU 251, data loaded by the CPU 251, and the like.

The nonvolatile memory 254 stores various kinds of setting information, programs, and the like.

The CPU 251 can execute various kinds of processing based on data such as applications stored in the storage unit 274.

Also, the control unit 250 can generate video signals to be displayed of various screens and the like in accordance with applications executed by the CPU 251, and can display the screens on the display 234. Furthermore, the control unit 250 can generate audio signals to be played back of various sounds in accordance with applications executed by the CPU 251, and can output the sounds from the loudspeaker 222.

The loudspeaker 222 outputs sound based on a supplied audio signal.

The microphone 223 is a sound collecting unit which generates a signal (sound recording signal) based on an external sound of the portable device 200. The microphone 223 supplies a sound recording signal to the control unit 250.

The display 234 includes a liquid crystal display device including a liquid crystal display panel which includes a plurality of pixels arranged in a matrix, and a backlight which illuminates this liquid crystal display panel, and the like. The display 234 displays a video based on a video signal.

The touch sensor 235 is a device which generates position information based on a capacitive sensor, thermosensor, or other systems. For example, the touch sensor 235 is integrally arranged on the display 234. Thus, the touch sensor 235 can generate an operation signal based on an operation on the screen displayed on the display 234, and can supply the operation signal to the control unit 250.

Note that the control unit 250 shifts to a lock state (screen lock) when an operation is not input for a predetermined time or longer, so as to prevent the touch sensor 235 from being erroneously operated. In the lock state, the portable device 200 restricts some operation inputs. For example, in the lock state, the portable device 200 invalidates operations except for a predetermined operation by the touch sensor 235 and those except for a predetermined operation by the operation input unit 264.

When a pre-set operation input (unlock operation) is input in the lock state, the portable device 200 unlocks the lock state. For example, in the lock state, the portable device 200 accepts only a pre-set operation input by the operation input unit 264 or touch sensor 235.

The operation input unit 264 includes, for example, keys used to generate operation signals according to operation inputs by the user. The operation input unit 264 includes, for example, a volume adjustment key used to adjust a volume, a luminance adjustment key used to adjust a display luminance level of the display 234, a power key used to switch a power supply state of the portable device 200, and the like. Also, the operation input unit 264 may further include a track ball which allows the portable device 200 to execute various selection operations and the like. The operation input unit 264 generates an operation signal according to the key operation, and supplies the operation signal to the control unit 250.

The operation input unit 264 may have an arrangement which inputs operation signals from a keyboard, mouse, or other input devices which can generate operation signals. For example, when the portable device 200 includes a USB terminal, a Bluetooth® module, or the like, the operation input unit 264 receives an operation signal from an input device connected via USB or Bluetooth, and supplies the operation signal to the control unit 250.

The communication unit 271 can communicate with other apparatuses on the network 400 via a LAN or wireless LAN and the wireless communication device 300. Also, the communication unit 271 can communicate with other apparatuses on the network 400 via a mobile phone network. Thus, the portable device 200 can communicate with other apparatuses connected to the wireless communication device 300. For example, the portable device 200 can acquire and play back a moving image, photo, music data, Web content, and the like recorded in an apparatus on the network 400 via the communication unit 271.

The MHL controller 273 is an interface which supports communication conforming to the MHL standard. The MHL controller 273 executes signal processing conforming to the MHL standard. Also, the MHL controller 273 has a USB terminal (not shown) which can receive an MHL cable.

The portable device 200 can output a stream to an apparatus (sink) connected to the USB terminal of the MHL controller 273.

Furthermore, the MHL controller 273 can generate a stream by multiplexing a video signal to be displayed and an audio signal to be played back.

For example, when the MHL cable is connected to the USB terminal of the MHL controller 273, and the portable device 200 operates as a source, the control unit 250 supplies video signal to be displayed and an audio signal to be played back to the MHL controller 273. The MHL controller 273 can generate a stream of various formats (for example, 1080i, 60 Hz) using the video signal to be displayed and audio signal to be played back. The MHL controller 273 can output the generated stream to the sink connected to the USB terminal.

The portable device 200 includes a power source unit (not shown). The power source unit includes a battery, and a terminal (for example, a DC jack) used to connect an adapter which receives electric power from a commercial power source. The power source unit charges the battery by electric power received from the commercial power source. Also, the power source unit supplies electric power stored in the battery to respective units in the portable device 200.

The storage unit 274 includes a hard disk drive (HDD), solid-state drive (SSD), semiconductor memory, or the like. The storage unit 274 can store programs to be executed by the CPU 251 of the control unit 250, applications, content such as moving images, various data, and the like.

FIG. 4 shows a communication example conforming to the MHL standard. Note that this embodiment will explain the portable device 200 as a source and the video processing apparatus 100 as a sink.

The MHL controller 273 of the portable device 200 includes a transmitter 276 and a receiver (not shown). The MHL controller 175 of the video processing apparatus 100 includes a transmitter (not shown) and a receiver 176.

The transmitter 276 and receiver 176 are connected via an MHL cable. The MHL line includes lines VBUS, GND, CBUS, MHL+, MHL−, and the like.

The VBUS line is used to transmit electric power. For example, the sink supplies electric power of +5 V to the source via the VBUS line. The source can operate using electric power supplied from the sink via the VBUS line. For example, the power source unit of the portable device 200 as the source can charge the battery by electric power supplied from the sink via the VBUS line. The GND line is grounded.

The CBUS line is used to transmit, for example, a control signal such as a command. The CBUS line is used to transmit, for example, a Display Data Channel (DDC) command, MHL Sideband Channel (MSC) command, or the like in two ways. The DDC command is used to read Extended Display Identification Data (EDID), in High-bandwidth Digital Content Protection (HDCP) authentication, and so forth. The EDID is a list of display information, which is set in advance according to the specification of the display or the like. The MSC command is used in read/write control of various registers (not shown), remote controller control, and so forth.

For example, the video processing apparatus 100 as the sink outputs commands to the portable device 200 as the source via the CBUS line. The portable device 200 can execute various kinds of processing according to the received commands.

The source transmits the DDC command to the sink to execute HDCP authentication with the sink, and can read the EDID from the sink.

The HDCP is an encryption method of signals transmitted between the apparatuses. The video processing apparatus 100 and portable device 200 exchange keys and the like in the sequence conforming to HDCP, thus attaining mutual authentication.

Note that the portable device 200 may have an arrangement which acquires EDID from the video processing apparatus 100 not during the HDCP authentication but at another timing.

The portable device 200 analyzes the EDID acquired from the video processing apparatus 100, and recognizes display information indicating a format including a resolution, color depth, transmission frequency, and the like, which can be processed by the video processing apparatus 100. The portable device 200 generates a stream in the format including the resolution, color depth, transmission frequency, and the like, which can be processed by the video processing apparatus 100.

The MHL+ and MHL− lines are used to transmit data. The two MHL+ and MHL− lines function as one twisted-pair line. For example, the MHL+ and MHL− lines function as a Transition Minimized Differential Signaling (TMDS) channel used to transmit data according on the TMDS method. The MHL+ and MHL− lines can transmit a sync signal (MHL clock) according to the TMDS method.

For example, the source can output a stream to the sink via the TMDS channel. That is, the portable device 200, which functions as the source, can transmit a stream obtained by converting video data (display screen) displayed on the display 234 and audio data output from the loudspeaker 222 to the video processing apparatus 100 as the sink. The video processing apparatus 100 receives the transmitted stream via the TMDS channel, and applies signal processing to the received stream, and plays back the processed stream.

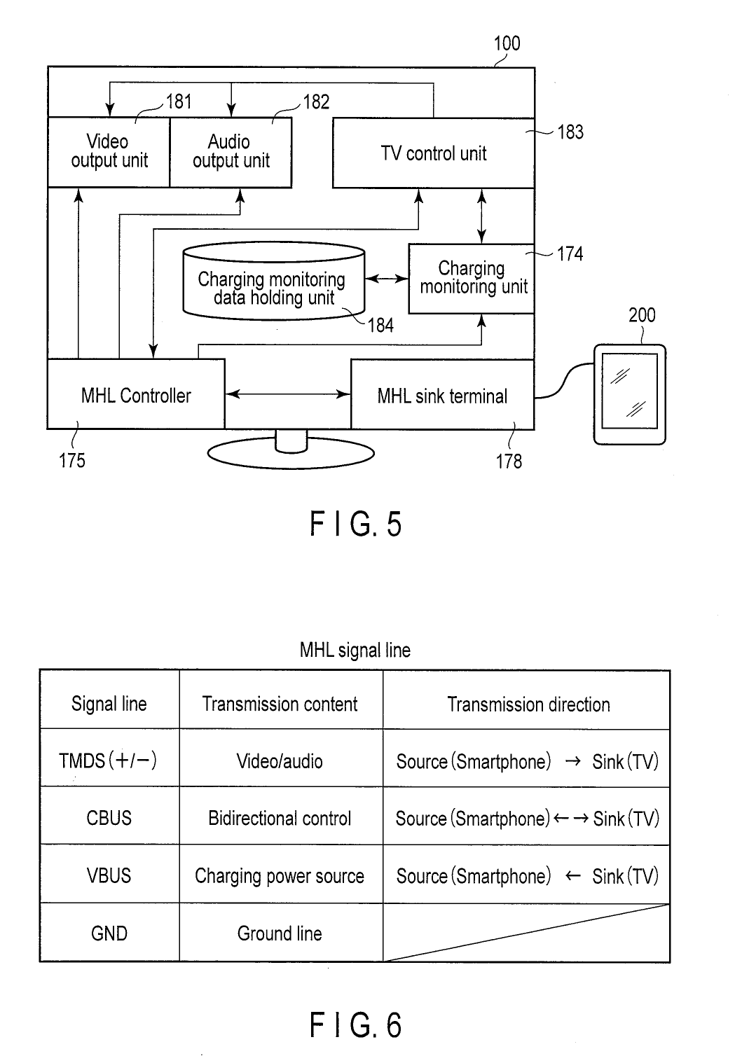

FIG. 5 is a view showing a connection example of the video processing apparatus 100 according to one embodiment and the portable device 200 (MHL source). The video processing apparatus 100 shown in FIG. 5 is obtained by simplifying that shown in FIG. 2.

The video processing apparatus 100 shown in FIG. 5 includes a video output unit 181 configured by the video processor 131, display processor 133, display 134, and the like, and an audio output unit 182 configured by the audio processor 121, loudspeaker 122, and the like. Furthermore, the video processing apparatus 100 includes a TV control unit 183 configured by the control unit 150 and the like. Moreover, the video processing apparatus 100 includes the MHL controller 175, connector (MHL sink terminal) 178, and charging monitoring unit 174. In addition, the video processing apparatus 100 includes a charging measurement data holding unit 184 configured by the storage 160.

FIG. 6 shows an example of MHL signal lines. As shown in FIG. 6, the MHL signal lines include the VBUS line, and can supply electric power from an MHL sink to an MHL source.

The MHL controller 175 controls the connector 178. Video and audio signals input via the connector 178 are output by the video output unit 181 and audio output unit 182 via the MHL controller 175. The TV control unit 183 controls respective functions based on a control instruction input via the connector 178, and outputs a control instruction to the portable device 200.

The power supply unit 179 shown in FIG. 2 supplies electric power to the portable device 200 connected via the MHL cable and connector 178. The charging monitoring unit 174 monitors (measures) a supplied power (supplied current) by the power supply unit 179. The charging monitoring unit 174 measures (detects) a change in supplied power according to an elapse of time, predicts a charging status of the portable device 200 based on the measurement result of the supplied power, and generates a charging status guide associated with the charging status (prediction). The charging monitoring data holding unit 184 stores at least one of the measurement result of the supplied power, charging status prediction, and charging status guide.

The TV control unit 183 issues an output instruction of at least one item of information of the measurement result of the supplied power, charging status prediction, and charging status guide. In response to this instruction, at least one of the video output unit 181 and audio output unit 182 outputs at least one item of information of the measurement result of the supplied power, charging status prediction, and charging status guide.

For example, the video output unit 181 outputs a video of the graphic charging status prediction. Alternatively, the video output unit 181 superimposes a video of the graphic charging status prediction on a content video which is being played back. The content video which is being played back may be that received from the portable device 200 via the connector 178, that on the air which is received via the tuner 111, or that acquired via the storage 160 or LAN interface 171 (network).

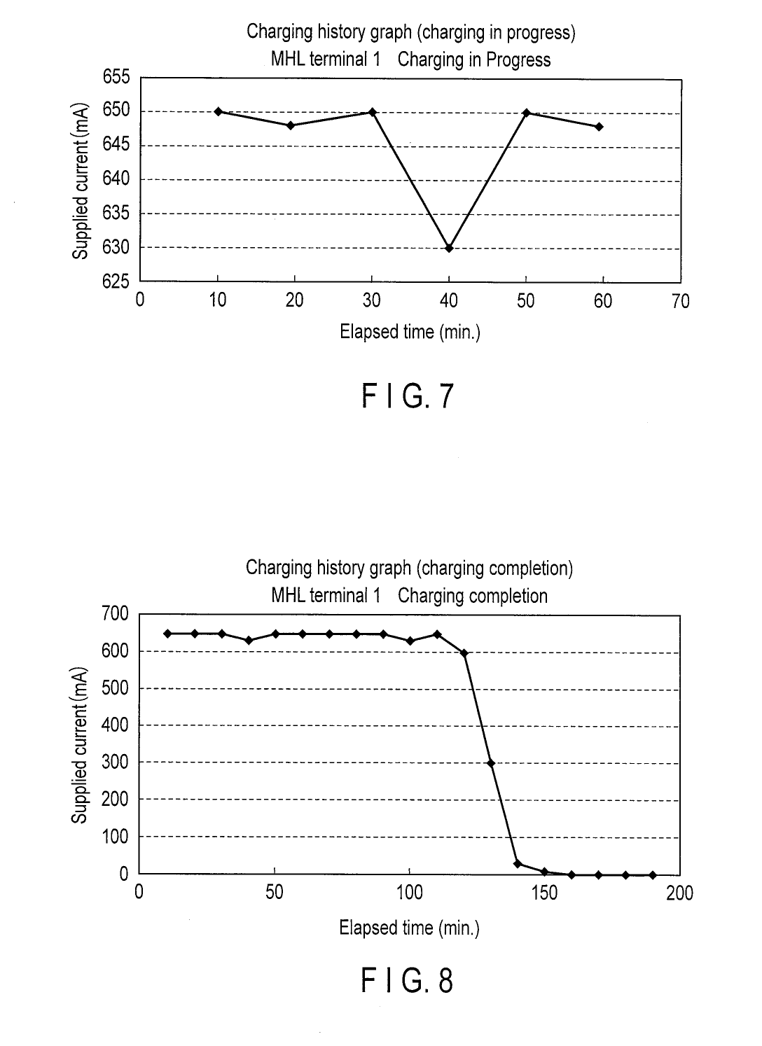

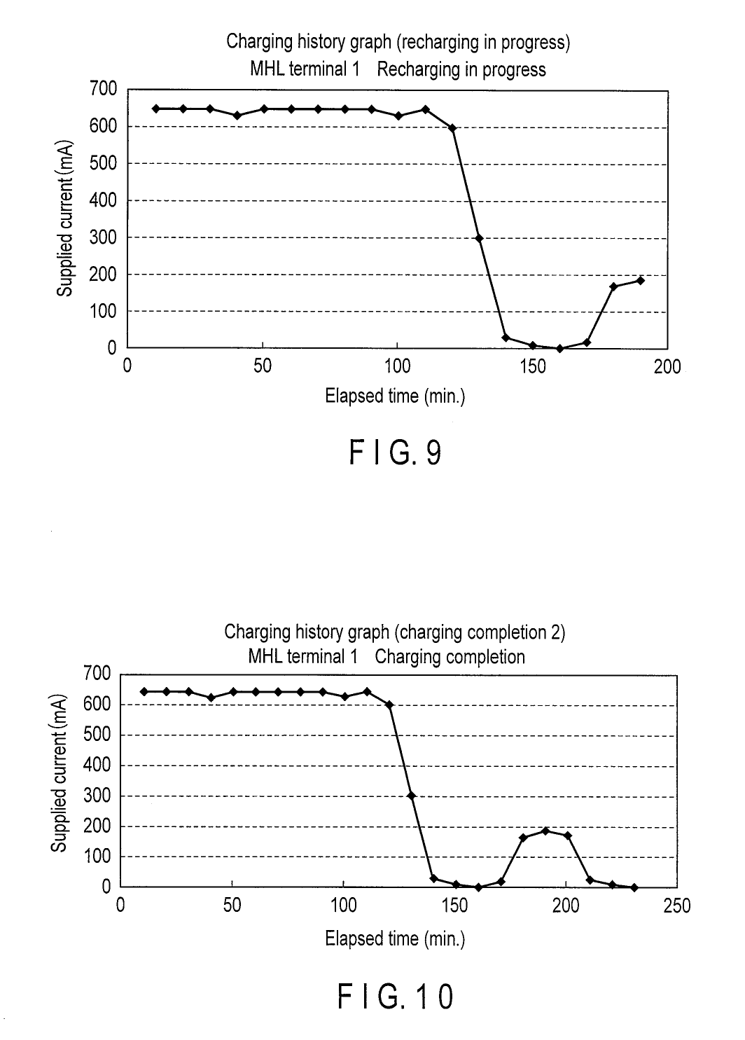

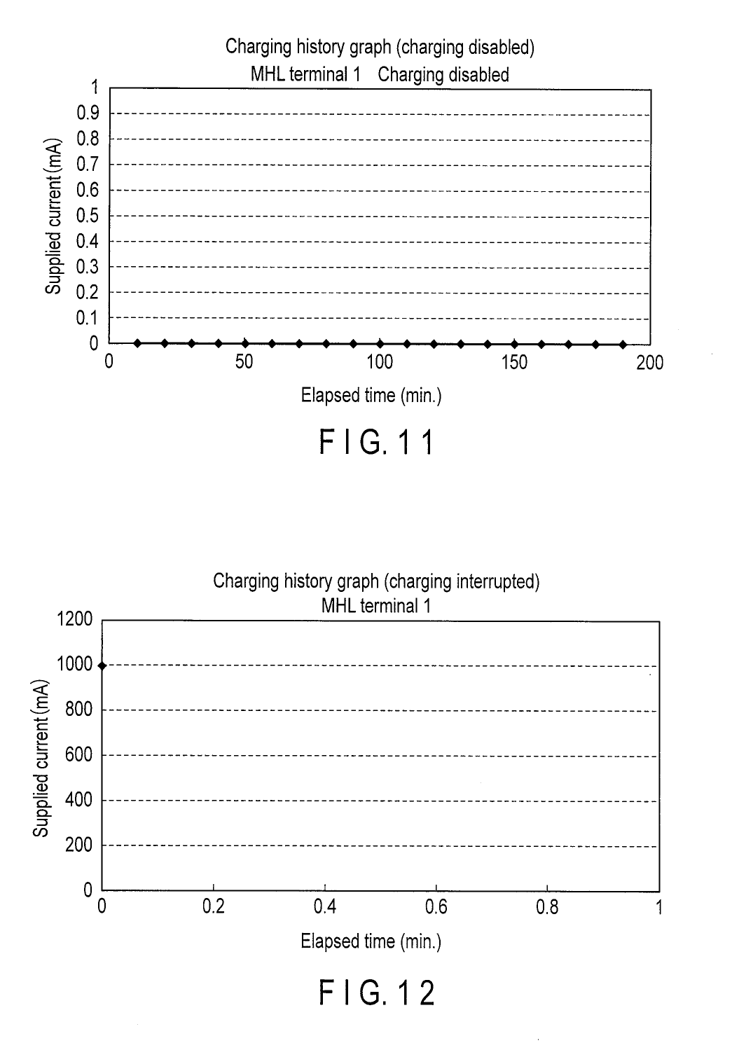

The video output unit 181, audio output unit 182, TV control unit 183, and the like output (display) the charging status in various modes. For example, the video output unit 181, audio output unit 182, TV control unit 183, and the like output (display) the charging status by means of a graph. For example, the charging status includes “charging in progress” (FIG. 7), “charging completion” (FIGS. 8 and 10), “recharging in progress” (FIG. 9), “charging disabled” (FIG. 11), “charging interrupted” (FIG. 12), and the like, and their details are as follows.

Charging in progress: Power supply to an external apparatus is currently in progress via the connector.

Charging completion: After an external apparatus was connected to the connector, electric power was supplied to the external apparatus via the connector, and the external apparatus is currently connected via the connector, but no electric power is supplied.

Recharging in progress: After an external apparatus was connected to the connector, electric power was supplied to the external apparatus via the connector, and power supply is in progress again via a non-power supply status.

Charging disabled: After an external apparatus was connected to the connector, electric power of a predetermined magnitude or more cannot be supplied even after the elapse of a predetermined time.

Charging interrupted: After an external apparatus was connected to the connector, power supply to the external apparatus was interrupted after monitoring of power supply of a predetermined magnitude or more.

Note that the video output unit 181, audio output unit 182, TV control unit 183, and the like output (display) at least one of the plurality of aforementioned charging statuses. Alternatively, the video output unit 181 alone may output the charging status, the audio output unit 182 alone may output the charging status, and both the video output unit 181 and audio output unit 182 may output the charging status.

Furthermore, the TV control unit 183 may control to predict a charging status in the future using at least one of the stored previous current, electric power, power, and charging status, to calculate a prediction time until charging completion, and to output the calculated prediction time (charging completion prediction time).

As described above, the user can confirm a charging status on a display of an MHL sink (video processing apparatus) irrespective of a use state of an MHL source (portable device) and the viewing content of the MHL sink. That is, the user can recognize the charging status on the MHL sink side by confirming a charging status output on the MHL sink side without turning on the power source of the MHL source. That is, the user can recognize the charging status on the MHL sink side by confirming the charging status output on the MHL sink side without playing back any video on the MHL source.

This embodiment will be summarized below.

(1) The MHL sink (video processing apparatus) according to one embodiment monitors a supplied power to the MHL source (portable device), holds the monitoring result, predicts a charging status of the MHL source based on the monitoring result, and outputs the predicted charging status.

(2) The MHL sink (video processing apparatus) according to one embodiment monitors a change in supplied power to the MHL source according to an elapse of time, holds the monitoring result, predicts a charging status of the MHL source based on the monitoring result, and outputs the predicted charging status. That is, the MHL sink (video processing apparatus) periodically monitors a supplied power to the MHL source (portable device) a plurality of times, holds the monitoring results, predicts the charging status of the MHL source based on the monitoring results, and outputs the predicted charging status.

For example, the MHL sink monitors a supplied power from a supplied current. For example, the MHL sink outputs the monitoring result using, for example, a line graph which plots elapsed time on the abscissa and current on the ordinate. For example, the charging status is any of “charging in progress”, “charging completion”, “recharging in progress”, “charging disabled”, and “charging interrupted”. Alternatively, the charging status is a charging completion prediction time.

The MHL sink can send a predetermined control command (by settings at the time of factory delivery or by the user) to the MHL source based on the charging status via the CBUS line.

The MHL sink can also output the charging status under a predetermined condition (by settings at the time of factory delivery or by the user) based on the charging status.

The MHL sink can also output a predetermined charging status (predetermined one of “charging in progress”, “charging completion”, “recharging in progress”, “charging disabled”, and “charging interrupted”) (by settings at the time of factory delivery or by the user).

Note that this embodiment has explained the case in which the MHL sink includes one connector (MHL sink terminal) 178, supplies electric power to one MHL source via one connector (MHL sink terminal) 178, stores a charging status of one MHL source, and outputs the charging status. However, the present invention is not limited to this. For example, the MHL sink may include a plurality of connectors, may supply electric power to a plurality of MHL sources via the respective connectors, may store charging statuses of the plurality of MHL sources, and may output the charging statuses.

The various modules of the embodiments described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An information processing apparatus comprising:
a terminal conforming to the mobile high-definition link (MHL) standard and configured to receive an MHL cable from a chargeable external apparatus;
a power supply to supply electric power to the external apparatus via the terminal when the external apparatus is connected to the information processing apparatus; and
a processor
to measure a supplied power supplied from the power supply,
to predict a charging status of the external apparatus based on the measurement result of the supplied power,
to detect a change in the supplied power over a period of time, and
to output the charging status.

2. (canceled)

3. The apparatus of claim 1, further comprising a memory configured to store the charging status.

4. The apparatus of claim 1, wherein the processor is configured to display the charging status.

5. The apparatus of claim 1, wherein the processor is configured to measure the supplied power based on a current supplied from the power supply.

6. (canceled)

7. The apparatus of claim 1, wherein the processor is configured to predict the charging status of the external apparatus based on the change in the supplied power over the period of time.

8. The apparatus of claim 7, wherein the processor is configured to predict at least one status of “charging in progress”, “charging completion”, “recharging in progress”, “charging disabled”, and “charging interrupted” based on the change in the supplied power over the period of time.

9. The apparatus of claim 8, wherein the processor is configured to output at least one designated status of “charging in progress”, “charging completion”, “recharging in progress”, “charging disabled”, and “charging interrupted”.

10. (canceled)

11. An information processing method comprising:
supplying electric power to a chargeable external apparatus via a terminal connected to a mobile high-definition link (MHL) cable conforming to the MHL standard from the external apparatus;
measuring the supplied power;
predicting a charging status of the external apparatus based on the measured supplied power;
detecting a change in the supplied power over a period of time, and
outputting the charging status.

12. An electric apparatus capable of charging a battery of a portable terminal connected via a mobile high-definition link (MHL) cable and playing back broadcast signals, the electric apparatus comprising:
a terminal conforming to the MHL standard and configured to receive an MHL cable from a chargeable external apparatus;
a power supply to supply electric power to the external apparatus via the terminal when the external apparatus is connected to the electric apparatus; and
a processor
to measure a supplied power supplied from the power supply,
to predict a charging status of the external apparatus based on the measurement result of the supplied power,
to detect a change in the supplied power over a period of time, and
to output the charging status.

13. The apparatus of claim 12, wherein the processor is configured to predict the charging status of the external apparatus based on the charge in the supplied power over the period of time.

14. The apparatus of claim 13, wherein the processor is configured to predict at least one status of “charging in progress”, “charging completion”, “recharging in progress”, “charging disabled”, and “charging interrupted” based on the change in the supplied power over the period of time.

15. The apparatus of claim 14, wherein the processor is configured to output at least one designated status of “charging in progress”, “charging completion”, “recharging in progress”, “charging disabled”, and “charging interrupted”.
